(19) United States
(12) Patent Application Publication
(10) Pub. No.: US 2025/0140879 A1
(43) Pub. Date: May 1, 2025

(54) REWORKABLE FUEL CELL STACK

(71) Applicants: Hyundai Motor Company, Seoul (KR); Kia Corporation, Seoul (KR)

(72) Inventors: Myung Young An, Incheon (KR); Seung Ah Yu, Yongin-si (KR); Yong In Cho, Yongin-si (KR)

(21) Appl. No.: 18/413,331

(22) Filed: Jan. 16, 2024

(30) Foreign Application Priority Data
Oct. 27, 2023 (KR) 10-2023-0145173

(51) Int. Cl. H01M 8/0276; H01M 8/0267; H01M 8/028; H01M 8/1004

(52) U.S. Cl. CPC H01M 8/0276; H01M 8/0267; H01M 8/028; H01M 8/1004

(57) ABSTRACT

An embodiment includes a reworkable fuel cell stack in which a first separator and a second separator forming one fuel cell are bonded to a membrane electrode assembly (MEA) by a hot-melt adhesive, the first separator is bonded to a third separator of another fuel cell by a first UV adhesive film, and the second separator is bonded to a fourth separator of yet another fuel cell by a second UV adhesive film, so that, among a plurality of fuel cells, a specific fuel cell that is defective is easily selectively separated from the fuel cell stack, and is easily replaced with a new or replacement fuel cell.

### CROSS-REFERENCE TO RELATED APPLICATIONS

This application claims the benefit of Korean Patent Application No. 10-2023-0145173, filed on Oct. 27, 2023, which application is hereby incorporated herein by reference.

### TECHNICAL FIELD

The present disclosure relates to a reworkable fuel cell stack.

### BACKGROUND

A fuel cell stack mounted in a fuel cell vehicle, or the like, configured to produce electricity is manufactured in a structure in which tens to hundreds of fuel cells, each of which includes a membrane electrode assembly (MEA) and two or more separators, are stacked.

The MEA includes a polymer electrolyte membrane, and a cathode and an anode applied to both surfaces of the electrolyte membrane to react with hydrogen and oxygen, respectively.

Further, gas diffusion layers (GDLs), gaskets, and the like, are stacked outside the cathode and the anode, and the separators are stacked outside the GDLs.

In the case that a defective MEA or a defective separator is included in a specific fuel cell when the fuel cell stack is assembled, or in the case that a specific fuel cell is defective or malfunctions during driving of the fuel cell stack, the fuel cell stack may be disassembled for repair.

However, when the fuel cell stack including the defective MEA or the defective separator is disassembled for repair, problems, such as change in the dimensions of the MEA due to contraction of the MEA caused by evaporation of moisture depending on exposure of the MEA to the air, or damage to the MEA due to mixing of external contaminants with the MEA during a process of replacing the fuel cell, may be caused.

Further, although the defective MEA is replaced with a new MEA, a performance deviation between the respective fuel cells of the fuel cell stack occurs due to an activation level difference between the defective MEA before replacement and the new MEA after replacement.

In addition, the separators of the fuel cell stack are formed of a thin metal material and may thus be easily deformed due to impact when the fuel cell stack is disassembled, and thereby, it is difficult to completely separate the separators from the fuel cell stack without deformation so as to reuse the separators.

Because the separators of the fuel cell stack are bonded to other elements (for example, gaskets or the like), heat should be applied to the separators to easily release the separators from the fuel cell stack.

For example, the separators may be separated from the fuel cell stack through various methods, such as by disposing the fuel cell stack in a chamber in a high-temperature state, by applying hot air directly to the separators, by applying heat to the separators using an iron, and the like.

However, in this case, an operation of placing the fuel cell stack in the chamber in the high-temperature state, an operation of applying hot air directly to the separators, or the like, is required to separate the separators from the fuel cell stack, and thus, release workability of the separators is greatly reduced.

The above information disclosed in this background section is only for enhancement of understanding of the background of the disclosure and therefore it may contain information that does not form prior art as defined in the patent statute.

### SUMMARY

The present disclosure relates to a reworkable fuel cell stack. More particularly, it relates to a reworkable fuel cell stack from which, among a plurality of fuel cells, a specific fuel cell may be easily selectively separated so that the defective fuel cell may be easily replaced.

An embodiment of the present disclosure has been made in an effort to solve the above-described problems associated with the prior art, and it is an advantage of an embodiment of the present disclosure to provide a reworkable fuel cell stack in which a first separator and a second separator forming one fuel cell can be bonded to a membrane electrode assembly (MEA) by a hot-melt adhesive, the first separator can be bonded to a third separator forming another fuel cell by a UV adhesive film, and the second separator can be bonded to a fourth separator forming yet another fuel cell by the UV adhesive film, so that, among a plurality of fuel cells, a specific fuel cell that is defective may be easily selectively separated from the fuel cell stack, and may be easily replaced with a new fuel cell.

In an embodiment of the present disclosure, a reworkable fuel cell stack includes one fuel cell including a membrane electrode assembly, and a first separator and a second separator stacked on both surfaces of the membrane electrode assembly, at least one subgasket fixed to a circumference of the membrane electrode assembly, a hot-melt adhesive applied to both surfaces of the at least one subgasket so as to be adhered to inner surfaces of the first separator and the second separators, and a UV adhesive film attached to an outer surface of the first separator so as to be adhered to a third separator of another fuel cell, and attached to an outer surface of the second separator so as to be adhered to a fourth separator of yet another fuel cell.

In an embodiment, in a case that a first gasket is fixed to an inner surface of the first separator and a second gasket can be fixed to an inner surface of the second separator, the hot-melt adhesive applied to both surfaces of the at least one subgasket may be respectively adhered to the first gasket and the second gasket.

In an embodiment, the at least one subgasket may be provided in a structure configured such that the hot-melt adhesive is applied to both surfaces thereof, and may be fixed to circumferences of a cathode of the membrane electrode assembly and a gas diffusion layer stacked outside the cathode.

In an embodiment, when the first gasket is adhered to the hot-melt adhesive applied to one surface of the at least one subgasket and the second gasket is adhered to the hot-melt adhesive applied to a remaining surface of the at least one subgasket, one surface of both ends of an electrolyte membrane of the membrane electrode assembly may be adhered to the hot-melt adhesive applied to the remaining surface of the at least one subgasket.

In an embodiment, the at least one subgasket may include a first subgasket provided in a structure configured such that the hot-melt adhesive is applied to both surfaces thereof, and fixed to circumferences of a cathode of the membrane electrode assembly and a gas diffusion layer stacked outside the cathode, and a second subgasket provided in a structure configured such that the hot-melt adhesive is applied to both surfaces thereof, and fixed to circumferences of an anode of the membrane electrode assembly and a gas diffusion layer stacked outside the anode.

In an embodiment, when the first separator is adhered directly to the hot-melt adhesive applied to an outer surface of the first gasket and the second separator is adhered directly to the hot-melt adhesive applied to an outer surface of the second subgasket, one surface and a remaining surface of both ends of an electrolyte membrane of the membrane electrode assembly may be adhered to the hot-melt adhesive applied to inner surfaces of the first and second subgaskets.

In an embodiment, the hot-melt adhesive may be a polyolefin-based adhesive, a styrene butadiene rubber-based adhesive, butyl rubber having dispersive force of 20 mN/m or more and polar force of 0.01-1.91 mN/m, or any combination thereof, so as to be adhered to all of the at least one subgasket formed of polyethylene naphthalate (PEN), first and second gaskets formed of ethylene propylene diene monomer (EPDM), and an electrolyte membrane of the membrane electrode assembly.

In an embodiment, the hot-melt adhesive may be a polyolefin-based adhesive, a styrene butadiene rubber-based adhesive, butyl rubber having a softening point of 67-110° C., or any combination thereof.

In an embodiment, the UV adhesive film may include a film base formed of polyethylene terephthalate (PET), polyethylene naphthalate (PEN), an olefine-based material, or any combination thereof, and an adhesive applied to both surfaces of the film base.

In an embodiment, the adhesive applied to both surfaces of the film base may be an acrylic material, multifunctional acrylic urethane, epoxy acryl, or any combination thereof.

In an embodiment, the adhesive applied to both surfaces of the film base may include 2,4,6-trimethylbenzoyldiphenyl phosphine oxide (TPO) as a photoinitiator configured to create radicals when the adhesive is irradiated with UV light.

In an embodiment, the adhesive applied to both surfaces of the film base may include a UV absorber or a light stabilizer configured to adjust sensitivity to UV light.

In an embodiment, third gaskets may be further placed between the first separator and the third separator and between the second separator and the fourth separator, in addition to the UV adhesive film.

In an embodiment, heat generated by UV light radiated to the UV adhesive film by a UV light irradiator may be blocked by the first and second separators and the first and second gaskets so as not to be conducted to the hot-melt adhesive.

In an embodiment, an amount of the UV light radiated to the UV adhesive film by the UV light irradiator may be adjusted to less than a designated level for a long period of a designated time or longer, so that the heat generated by the UV light radiated to the UV adhesive film is not to be conducted to the hot-melt adhesive.

In an embodiment, an adhesion area of the UV adhesive film may be reduced to less than an application area of the hot-melt adhesive so that heat capacity generated by UV light radiated to the UV adhesive film is set to a level not to melt the hot-melt adhesive.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to example embodiments thereof illustrated in the accompanying drawings which are given hereinbelow by way of illustration, and thus are not necessarily limitative of the present disclosure, and wherein:

FIG. 1 is a cross-sectional view showing a reworkable fuel cell stack according to an embodiment of the present disclosure;

FIGS. 2 to 7 are cross-sectional views sequentially showing a process of replacing a fuel cell to be replaced of the fuel cell stack according to an embodiment of the present disclosure with a new fuel cell;

FIGS. 8 to 12 are cross-sectional views sequentially showing a process of replacing an MEA of a fuel cell to be replaced of the fuel cell stack according to an embodiment of the present disclosure with a new MEA;

FIG. 13 is a cross-sectional view showing a reworkable fuel cell stack according to an embodiment of the present disclosure;

FIG. 14 is a cross-sectional view showing a reworkable fuel cell stack according to an embodiment of the present disclosure;

FIG. 15 is a graph representing adhesive force evaluation results of a hot-melt adhesive used in a reworkable fuel cell stack according to an embodiment of the present disclosure; and

FIG. 16 is a graph representing release force measurement results of a hot-melt adhesive used in a reworkable fuel cell stack according to an embodiment of the present disclosure.

It can be understood that the appended drawings are not necessarily to scale, presenting a somewhat simplified representation of various features illustrative of embodiments of the disclosure. The specific design features of an embodiment of the present disclosure as disclosed herein, including, for example, specific dimensions, orientations, locations, and shapes, can be determined in part by the particular intended application and use environment.

In the figures, reference numbers can refer to same or equivalent parts of embodiments of the present disclosure throughout the several figures of the drawing.

### DETAILED DESCRIPTION OF ILLUSTRATIVE EMBODIMENTS

Specific structural or functional descriptions in embodiments of the present disclosure set forth in the description which follows are examples, and the present disclosure may be embodied in many alternative forms. Further, it can be understood that the present disclosure should not necessarily be construed as being limited to the embodiments set forth herein, and the embodiments of the present disclosure are provided only to completely disclose the disclosure and provide insight for modifications, equivalents, or alternatives that come within the scope and technical range of the disclosure.

In the following description of the embodiments, terms, such as “first” and “second”, can be used to describe various elements, and these elements should not necessarily be construed as being limited by these terms. These terms can be used to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements can be interpreted in a like fashion, e.g., “between” versus “directly between,” “adjacent” versus “directly adjacent,” etc.

Wherever possible, the same reference numbers will be used throughout the drawings to refer to the same or like parts. The terminology used herein is for the purpose of describing particular embodiments only and is not necessarily intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

Hereinafter, reference will be made in detail to various embodiments of the present disclosure, examples of which are illustrated in the accompanying drawings and described below.

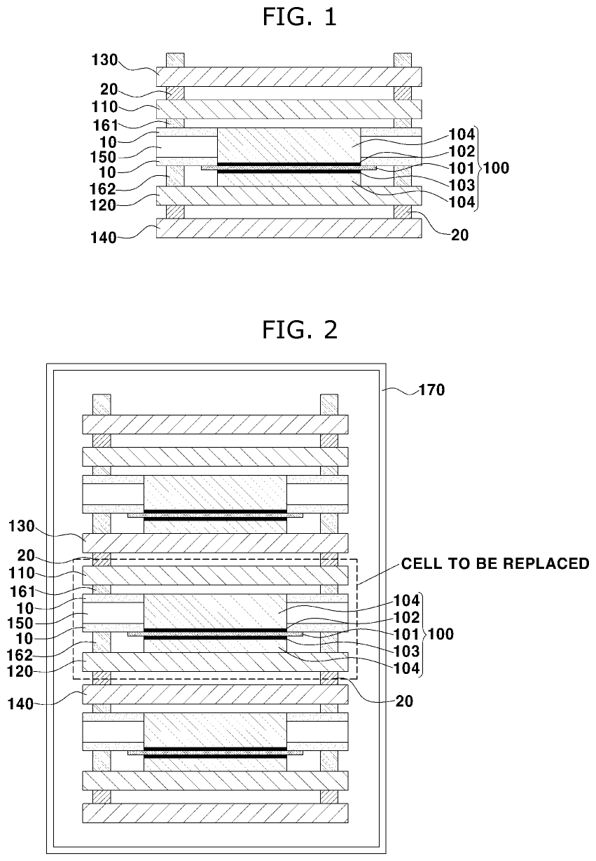

FIG. 1 is a cross-sectional view showing a reworkable fuel cell stack according to an embodiment of the present disclosure, and reference numeral 100 indicates a membrane electrode assembly (MEA).

The MEA 100 can include a polymer electrolyte membrane 101, a cathode 102 and an anode 103 applied to both surfaces of the electrolyte membrane 101 and configured to react with hydrogen and oxygen, and gas diffusion layers 104 can be attached to the outer surfaces of the cathode 102 and the anode 103.

Further, a first separator 110 and a second separator 120 can be stacked on both surfaces of the MEA 100.

The first separator 110 can be stacked outside the gas diffusion layer 104 attached to the cathode 102 of the MEA 100, and the second separator 120 can be stacked outside the gas diffusion layer 104 attached to the anode 103 of the MEA 100.

Thereby, the MEA 100, the first separator 110, and the second separator 1200 may form one fuel cell.

The fuel cell stack can be manufactured in a structure in which tens to hundreds of fuel cells, each of which includes a membrane electrode assembly (MEA) and two or more separators, are stacked, and therefore, as shown in FIG. 1, a third separator 130 of another fuel cell may be stacked on the outer surface of the first separator 110, and a fourth separator 140 of yet another fuel cell may be stacked on the outer surface of the second separator 120.

A gap between the inner surface of the first separator 110 and the MEA and a gap between the inner surface of the second separator 120 and the MEA 100 may be set to reactive planes for electrochemical reactions, such as redox reaction between hydrogen and oxygen occurring in the MEA 100.

Particularly, a subgasket 150 configured such that a hot-melt adhesive 10 is applied to both surfaces thereof can be fixed to the circumference of the MEA 100 located between the first separator 110 and the second separator 120, the first gasket 161 can be fixed to the edge of the inner surface of the first separator 110, and the second gasket 162 can be fixed to the edge of the inner surface of the second separator 120.

The subgasket 150, the first gasket 161, and the second gasket 162 can function to airtightly and watertightly seal the reactive planes provided between the inner surface of the first separator 110 and the MEA 100 and between the inner surface of the second separator 120 and the MEA 100.

Particularly, the subgasket 150 can be configured such that the hot-melt adhesive 10 is applied to both surfaces thereof and may be located at the circumferences of the cathode 102 of the MEA 100 and the gas diffusion layer 104 stacked outside the cathode 102.

The first gasket 161 may be attached to the hot-melt adhesive 10 applied to one surface of the subgasket 150, the second gasket 162 may be attached to the hot-melt adhesive 10 applied to the other surface of the subgasket 150, and one surface of both ends of the electrolyte membrane 101 of the MEA 100 may be adhered to the hot-melt adhesive 10 applied to the other surface of the subgasket 150.

The hot-melt adhesive 10 may use a material that may be adhered to all of the subgasket 150 formed of polyethylene naphthalate (PEN), the first and second gaskets 161 and 162 formed of ethylene propylene diene monomer (EPDM), and the electrolyte membrane 101 formed of Nafion.

For example, given that the first and second gaskets 161 and 162 formed of EPDM can have dispersive force, which is a kind of surface energy, of 23.55 mN/m and polar force of 0.01 mN/m, and the subgasket 150 formed of PEN can have dispersive force of 44.51 mN/m and polar force of 1.91 mN/m, the hot-melt adhesive 10 may use a material having dispersive force of 20 mN/m or more and polar force of 0.01-1.91 mN/m, preferably 0.5-1.7 mN/m. Although the electrolyte membrane 101 can be well attached to the hot-melt adhesive 10, the hot-melt adhesive 10 may not be adhered to the first and second gaskets 161 and 162 formed of EPDM, when the polar force of the hot-melt adhesive 10 is excessively high, i.e., is higher than the range of 0.01-1.91 mN/m, and may not be adhered to the subgasket 150 formed of PEN, when the polar force of the hot-melt adhesive 10 is excessively low, i.e., is lower than the range of 0.01-1.91 mN/m.

Further, the hot-melt adhesive 10 may use a material having a softening point of 67-110° C., and the hot-melt adhesive 10 may continue to exhibit adhesive force to the subgasket 150, the first and second gaskets 161 and 162, the electrolyte membrane 101, and the like, at a temperature range of 60-70° C. during the activation operation of the fuel cell stack, but may exhibit reduced adhesive force so as to easily separate the MEA of a specific fuel cell from the fuel cell stack at a softening point (for example, 90° C. or higher) depending on heating of the hot-melt adhesive 10.

A polyolefin-based adhesive, a styrene butadiene rubber-based adhesive, butyl rubber, or the like, which has dispersive force of 20 mN/m or more and polar force of 0.01-1.91 mN/m, preferably 0.5-1.7 mN/m, and has a softening point of 67-110° C., may be used as the hot-melt adhesive 10, for example.

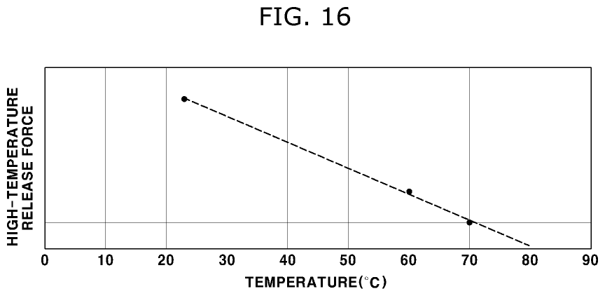

Adhesive force of the hot-melt adhesive 10 rapidly increases at a softening point of 60° C. or higher, as shown in FIG. 15 showing a graph representing adhesive force evaluation results of the hot-melt adhesive 10, but adhesive force of the hot-melt adhesive 10 converges on zero (0) at a temperature of 80° C. or higher, as shown in FIG. 16 showing a graph representing release force measurement results of the hot-melt adhesive 10.

Therefore, the MEA of the specific fuel cell may be easily separated from the fuel cell stack by reducing the adhesive force of the hot-melt adhesive 10 by heating the hot-melt adhesive 10 to a temperature of 80° C. or higher within a hot air chamber at a temperature of 90° C. or higher, for example.

Particularly, the first separator 110 and the third separator 130 can be bonded by an ultraviolet adhesive film 20, and the second separator 120 and the fourth separator 140 can be bonded by the ultraviolet adhesive film 20.

More concretely, the first separator 110 and the third separator 130 may be bonded by the UV adhesive film 20 by adhering the edge of the outer surface of the first separator 110 of one fuel cell and the edge of the outer surface of the third separator 130 of another fuel cell to each other by the UV adhesive film 20 interposed therebetween, and the second separator 120 and the fourth separator 140 may be bonded by the UV adhesive film 20 by adhering the edge of the outer surface of the second separator 120 of the fuel cell and the edge of the outer surface of the fourth separator 140 of yet another fuel cell to each other by the UV adhesive film 20 interposed therebetween.

A gap between the first separator 110 and the third separator 130 and a gap between the second separator 120 and the fourth separator 140 may be provided as cooling planes which function as a coolant passage and dissipate heat generated from the reactive planes.

The UV adhesive film 20 can function to airtightly and watertightly seal the cooling planes provided as the gap between the first separator 110 and the third separator 130 and the gap between the second separator 120 and the fourth separator 140, and loses adhesive force as curing using ultraviolet light is performed.

Particularly, as illustrated in FIG. 13, according to an embodiment of the present disclosure, in addition to the UV adhesive film 20, third gaskets 163 formed of ethylene propylene diene monomer may be used to reinforce airtight and watertight performance of the cooling planes provided as the gap between the first separator 110 and the third separator 130 and the gap between the second separator 120 and the fourth separator 140.

As shown in FIG. 13, the first separator 110 and the third separator 130 can be bonded by the UV adhesive film 20 in the state in which the third gasket 163 is between the first separator 110 and the third separator 130, and the second separator 120 and the fourth separator 140 can be bonded by the UV adhesive film 20 in the state in which the third gasket 163 is between the second separator 120 and the fourth separator 140.

The UV adhesive film 20 can include a film base and an adhesive applied to both surfaces of the film based and configured such that adhesive force thereof is rapidly reduced due to curing when ultraviolet light is applied thereto, one selected from among polyethylene terephthalate (PET), polyethylene naphthalate (PEN), and an olefine-based material may be used as the film base, and an acrylic material, multifunctional acrylic urethane, epoxy acryl or the like may be used as the adhesive applied to both surfaces of the film base, for example.

Further, the adhesive applied to the film base may include a photoinitiator which creates radicals when the adhesive is irradiated with UV light, such as 2,4,6-trimethylbenzoyldiphenyl phosphine oxide (TPO), and a UV absorber (for example, benzophenone) or a light stabilizer (for example, 2,2,6,6-tetramethyl piperidine) configured to adjust sensitivity to UV light, and thereby, the adhesive applied to the film base can have a soft property before irradiation with UV light, and can have a hard property after irradiation with UV light.

A UV light irradiator can be configured to irradiate the UV adhesive film 20 with UV light of a wavelength band of 200 nm to 405 nm may employ a short wavelength lamp using LEDs, a high pressure mercury lamp, a halogen lamp or the like, preferably an LED laser light source configured to radiate light of a wavelength of 365 nm.

Further, the UV light irradiator may radiate UV light of a wavelength of 365 nm to the UV adhesive film 20 so that an accumulated light amount is 700 mJ/cm², to prevent heat from being transmitted to the hot-melt adhesive 10 and to thereby prevent deterioration of adhesive force of the hot-melt adhesive 10.

Although the UV light irradiator can radiate UV light to the UV adhesive film 20 so that the accumulated light amount is 700 mJ/cm² or more, in an embodiment, heat should penetrate the first and second separators 110 and 120 formed of SUS and the first and second gaskets formed of EPDM to be conducted to the hot-melt adhesive 10, and therefore, the heat causing deterioration of adhesive force may not be easily transmitted to the hot-melt adhesive 10.

In an embodiment, although the UV light irradiator can radiate UV light to the UV adhesive film 20 so that the accumulated light amount is 700 mJ/cm² or more, the first and second separators 110 and 120 formed of SUS and the first and second gaskets formed of EPDM block conduction of heat generated by UV light to the hot-melt adhesive 10.

For example, in an embodiment, because thermal conductivity of EPDM that is the material of the first and second gaskets 161 and 162 is 0.25 W/m·K and thermal conductivity of stainless steel (SUS) that is the material of the first and second separators 110 and 120 is 16.2 W/m·K (in the case of SUS 307), heat generated when the UV adhesive film 20 is irradiated with UV light is not transmitted to the hot-melt adhesive 10 through the first and second gaskets 161 and 162 and, although the heat is transmitted to the hot-melt-adhesive 10 through the first and second separators 110 and 120 formed of stainless steel, the transmitted heat is not sufficient to melt the hot-melt adhesive 10.

Further, in an embodiment, when the amount of UV light radiated to the UV adhesive film 20 by the UV light irradiator is increased to a designated level or more for a short period less than a designated time, heat transmitted to the holt-melt adhesive 10 may be instantaneously raised to a temperature of 100-160° C., but when the amount of UV light radiated to the UV adhesive film 20 by the UV light irradiator is adjusted to less than the designated level for a long period of the designated time or longer, heat causing deterioration of adhesive force is not easily transmitted to the hot-melt adhesive 10.

Otherwise, by reducing the adhesion area of the UV adhesive film 20 compared to the application area of the hot-melt adhesive 10, heat causing deterioration of adhesive force is not easily transmitted to the hot-melt adhesive 10, although the UV light irradiator radiates UV light to the UV adhesive film 20.

The adhesion area of the UV adhesive film 20 can be reduced to less than the application area of the hot-melt adhesive 10 so that heat capacity generated by UV light radiated to the UV adhesive film 20 is set to a level not to melt the hot-melt adhesive 10.

By reducing the adhesion area of the UV adhesive film 20 compared to the application area of the hot-melt adhesive 10, the heat capacity generated by UV light radiated to the UV adhesive film 20 by the UV light irradiator can be set only to a level to lose adhesive force of the UV adhesive film 20 due to curing but not set to a level to completely melt the hot-melt adhesive 10, and accordingly, the adhesive force of the hot-melt adhesive 10 can be not reduced or lost although UV light is radiated to the UV adhesive film 20, for example.

Hereinafter, a process of replacing a fuel cell to be replaced of the fuel cell stack according to an embodiment of the present disclosure with a new fuel cell will be described in order.

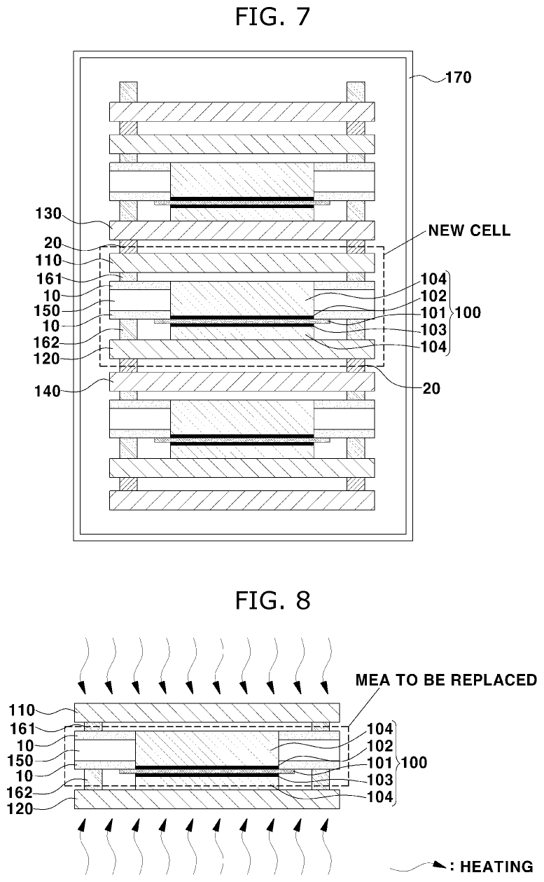

FIGS. 2 to 7 are cross-sectional views sequentially showing the process of replacing the fuel cell to be replaced of the fuel cell stack according to an embodiment of the present disclosure with the new fuel cell.

In the case that a defective MEA or a defective separator is included in a specific fuel cell when the fuel cell stack is assembled, or in the case that a specific fuel cell is defective or malfunctions during driving of the fuel cell stack, the specific fuel cell may be set to a fuel cell to be replaced, as shown in FIG. 2, and the fuel cell to be replaced may be easily replaced with a new fuel cell using an embodiment, for example.

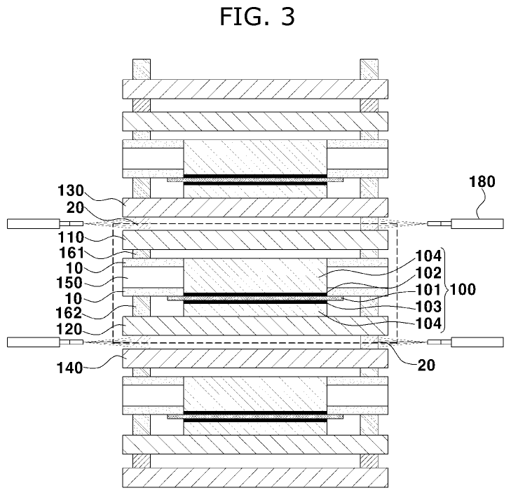

After a housing 170 configured to protect the fuel cell stack is disassembled, a UV light irradiator 180 can radiate UV light to the UV adhesive film 20 configured to adhere the first separator 110 and the third separator 130 to each other and the UV adhesive film 20 configured to adhere the second separator 120 and the fourth separator 140 to each other, as shown in FIG. 3.

Thereby, as curing of the UV adhesive film 20 by irradiation with UV light progresses, the UV adhesive film 20 may lose adhesive force.

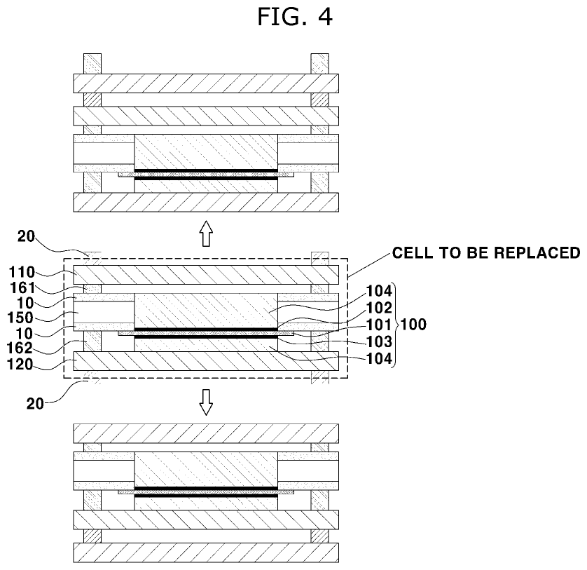

Thereafter, as shown in FIG. 4, the third separator 130 of another fuel cell may be easily separated from the first separator 110, the fourth separator 140 of yet another fuel cell may be easily separated from the second separator 120, and thereby, the fuel cell to be replaced which includes the first and second separators 110 and 120 may be easily separated from the fuel cell stack without any damage.

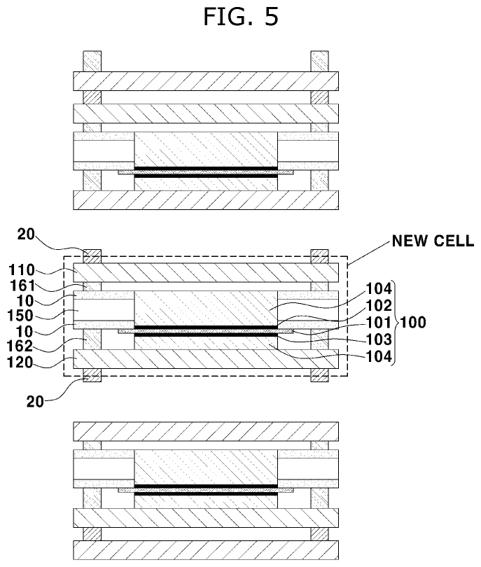

Thereafter, as shown in FIG. 5, a new or replacement fuel cell, i.e., a non-defective fuel cell, having the same configuration as the fuel cell to be replaced can be provided, and can be inserted into a position where the fuel cell to be replaced was located.

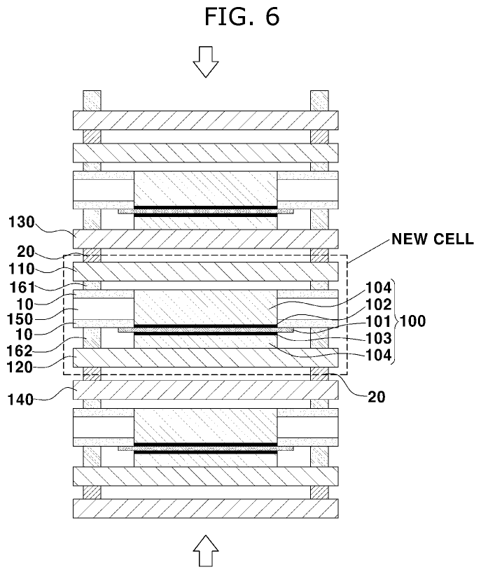

Subsequently, as shown in FIG. 6, the entirety of fuel cells including the new fuel cell can be fastened by applying a designated surface pressure thereto, and may thus be reassembled into a fuel cell stack.

A first separator 110 of the new fuel cell and the third separator 130 of another fuel cell may be adhered to each other by a UV adhesive film 20 applied in advance to the first separator 110, and a second separator 120 of the new fuel cell and the fourth separator 140 of yet another fuel cell may be adhered to each other by the UV adhesive film 20 applied in advance to the second separator 120.

Finally, the reassembled fuel cell stack can be again packaged into the housing 170.

The UV adhesive film 20 and the like can be protected by the housing 170, and thereby, the UV adhesive film 20 and the like may be protected from external heat or solar heat so as not to be cured.

As such, in the case that a defective MEA or a defective separator is included in a specific fuel cell forming the fuel cell stack, or in the case that a specific fuel cell is defective or malfunctions during driving of the fuel cell stack, the specific fuel cell, which is a fuel cell to be replaced, may be easily separated from the fuel cell stack without any damage so as to be reused, and may be easily replaced with a new fuel cell.

Hereinafter, a process of replacing an MEA of a fuel cell to be replaced of the fuel cell stack according to an embodiment of the present disclosure with a new EA fuel cell will be described in order.

FIGS. 8 to 12 are cross-sectional views sequentially showing a process of replacing the MEA of the fuel cell to be replaced of the fuel cell stack according to an embodiment of the present disclosure with the new or replacement MEA.

In the case that the membrane electrode assembly (MEA) included in the fuel cell to be replaced is defective after separation of the fuel cell to be replaced from the fuel cell stack, the MEA may be easily replaced with the new or replacement MEA that is not defective.

For this purpose, as shown in FIG. 8, the fuel cell to be replaced, separated from the fuel cell stack, can be heated to a designated temperature (for example, 90° C. or higher).

Thereby, the hot-melt adhesive 10 included in the fuel cell to be replaced may be heated to a softening point (for example, 90° C. or higher), and thus, the hot-melt adhesive 10 may lose almost all adhesive force, and the first gasket 161 and the second gasket 162 included in the fuel cell to be replaced may be easily separated from the hot-melt adhesive 10 applied to both surfaces of the subgasket 150.

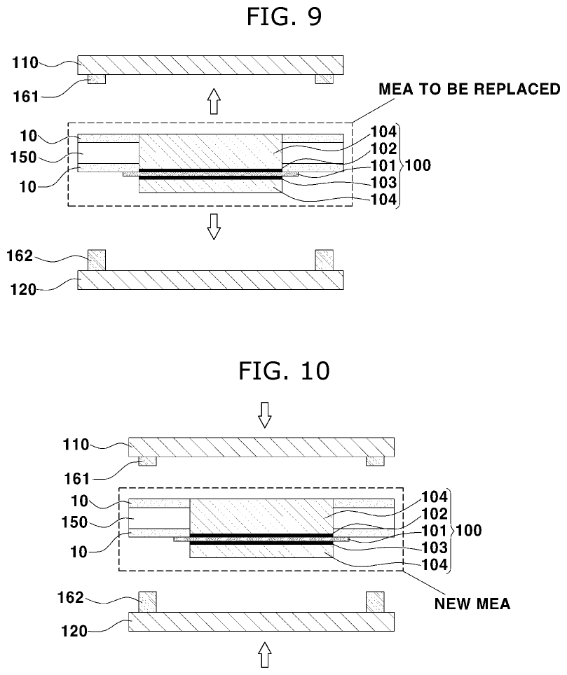

Since the fuel cell to be replaced is in the state in which the first gasket 161 fixed to the first separator 110 and the second gasket 162 fixed to the second separator 120 may be easily separated from the hot-melt adhesive 10, the first separator 110 and the second separator 120 may be easily removed from the MEA 100 included in the fuel cell to be replaced, and consequently, the MEA 100 to be replaced may be separated from the first and second separators 110 and 120, as shown in FIG. 9.

Thereafter, as shown in FIG. 10, a new or replacement MEA 100, i.e., a non-defective MEA 100, having the same configuration as the MEA 100 to be replaced can be provided, and can be inserted into a position between the first and second separators 110 and 120.

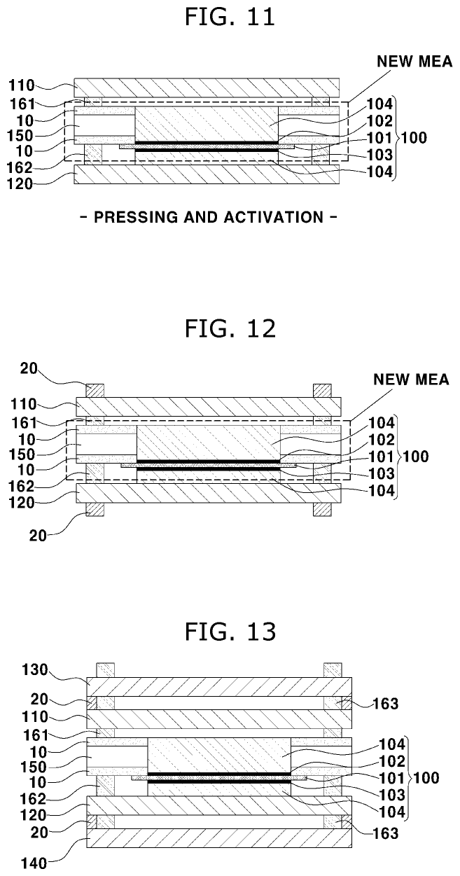

Thereafter, as shown in FIG. 11, a new fuel cell may be completed by fastening the first separator 110, the new MEA 100 and the second separator 120 by applying pressure thereto, and a known activation process configured to smoothly operate the new or replacement fuel cell can be performed.

Within a temperature range of 60 to 70° C. during operation of activating the new fuel cell 100, the hot-melt adhesive 10 included in the new or replacement fuel cell may exhibit adhesive force with respect to the subgasket 150, the first and second gaskets 161 and 162, the electrolyte membrane 101 and the like.

Finally, as shown in FIG. 12, a UV adhesive film 20 for adhesion of the first separator 161 and the second separator 162 with separators of other fuel cells is attached to the edges of the respective outer surfaces of the first separator 161 and the second separator 162.

As such, in the case that the membrane electrode assembly (MEA) included in the fuel cell to be replaced is defective after separation of the fuel cell to be replaced from the fuel cell stack, the MEA may be easily replaced with a new or replacement MEA that is not defective.

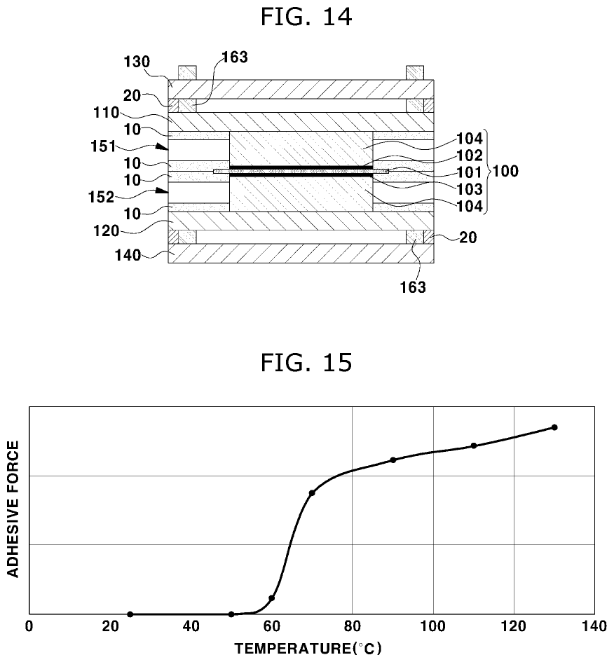

FIG. 14 is a cross-sectional view showing a reworkable fuel cell stack according to an embodiment of the present disclosure.

The reworkable fuel cell stack according to an embodiment of the present disclosure can have the same configuration as the reworkable fuel cell stack according to an embodiment previously described, and can be characterized in that the first separator 110 and the second separator 120 are adhered directly to the hot-melt adhesive 10 in the state in which the first gasket 161 and the second gasket 162 are omitted.

Two or more subgaskets 151 and 152 configured such that the hot-melt adhesive 10 is applied to both surfaces thereof can be provided at the circumference of the MEA 100, so that the hot-melt adhesive 10 may be attached directly to the inner surfaces of the first separator 110 and the second separator 120, thereby reducing the number of parts due to omission of the first gasket 161 and the second gasket 162.

As shown in FIG. 14, the first and second subgaskets 151 and 152 can be configured such that the hot-melt adhesive 10 is applied to both surfaces thereof are provided, the first subgasket 151 is located at the circumferences of the cathode 102 of the MEA 100 and the gas diffusion layer 104 stacked outside the cathode 102, and the second subgasket 152 can be located at the circumferences of the anode 103 of the MEA 100 and the gas diffusion layer 104 stacked outside the anode 103.

Subsequently, the first separator 110 and the second separator 120 can be stacked on the gas diffusion layer 104 stacked outside the cathode 102 and the gas diffusion layer 104 stacked outside the anode 103.

Thereby, the first separator 110 may be adhered directly to the hot-melt adhesive 10 applied to the outer surface of the first subgasket 151, the second separator 120 may be adhered directly to the hot-melt adhesive 10 applied to the outer surface of the second subgasket 152, and both surfaces of ends of the electrolyte membrane 101 of the MEA 100 may be adhered to the hot-melt adhesive 10 applied to the inner surfaces of the first and second subgaskets 151 and 152.

Therefore, in the state in which the first gasket 161 and the second gasket 162 are omitted, the first and second subgaskets 151 and 152 may function to airtightly and watertightly seal the reactive planes provided between the inner surface of the first separator 110 and the MEA 100 and between the inner surface of the second separator 120 and the MEA 100.

As can be apparent from the above description, an embodiment of the present disclosure can provide the following effects.

First, a first separator and a second separator forming one fuel cell can be bonded to a membrane electrode assembly (MEA) by a hot-melt adhesive, the first separator can be bonded to a third separator forming another fuel cell by a UV adhesive film, and the second separator can be bonded to a fourth separator forming yet another fuel cell by the UV adhesive film, thereby being capable of easily assembling a fuel cell stack.

Second, in the case that, among a plurality of fuel cells forming the fuel cell stack, a specific fuel cell is defective or malfunctions, the UV adhesive film can lose adhesive force by radiating UV light to the UV adhesive film included in the specific fuel cell, and thereby, only the specific fuel cell, which is a fuel cell to be replaced, may be easily separated from the fuel cell stack without any damage, and may then be easily replaced with a new fuel cell.

Third, in the case that the MEA included in the fuel cell to be replaced is defective after separation of the fuel cell to be replaced from the fuel cell stack, the hot-melt adhesive can lose adhesive force through heating, and thereby, only the defective MEA may be easily separated from the fuel cell, and may then be easily replaced with a new MEA.

The disclosure has been described in detail with reference to example embodiments thereof. However, it can be appreciated by those skilled in the art that changes may be made in these embodiments without departing from the principles and spirit of the disclosure, the scope of which can be defined in the appended claims and their equivalents.

What is claimed is:

1. A reworkable fuel cell stack comprising:
one fuel cell comprising a membrane electrode assembly, a first separator and a second separator stacked on both surfaces of the membrane electrode assembly;
at least one subgasket fixed to a circumference of the membrane electrode assembly;
a hot-melt adhesive applied to both surfaces of the at least one subgasket so as to be adhered to inner surfaces of the first separator and the second separators; and
a UV adhesive film attached to an outer surface of the first separator configured to be adhered to a third separator of another fuel cell, and attached to an outer surface of the second separator configured to be adhered to a fourth separator of yet another fuel cell.

2. The reworkable fuel cell stack of claim 1, wherein a first gasket is fixed to an inner surface of the first separator, wherein a second gasket is fixed to an inner surface of the second separator, and wherein the hot-melt adhesive applied to both surfaces of the at least one subgasket is respectively adhered to the first gasket and the second gasket.

3. The reworkable fuel cell stack of claim 2, wherein the first gasket is adhered to the hot-melt adhesive applied to one surface of the at least one subgasket, wherein the second gasket is adhered to the hot-melt adhesive applied to a remaining surface of the at least one subgasket, and wherein one surface of both ends of an electrolyte membrane of the membrane electrode assembly is adhered to the hot-melt adhesive applied to the remaining surface of the at least one subgasket.

4. The reworkable fuel cell stack of claim 2, wherein the hot-melt adhesive is one selected from among a polyolefin-based adhesive, a styrene butadiene rubber-based adhesive, and butyl rubber having dispersive force of 20 mN/m or more and polar force of 0.01-1.91 mN/m,
wherein the hot-melt adhesive is adhered to the at least one subgasket, the at least one subgasket being formed of polyethylene naphthalate (PEN),
wherein the hot-melt adhesive is adhered to the first and second gaskets, the first and second gaskets being formed of ethylene propylene diene monomer (EPDM), and
wherein the hot-melt adhesive is adhered to an electrolyte membrane of the membrane electrode assembly.

5. The stack of claim 2, wherein the first and second separators and the first and second gaskets are configured such that at least part of heat generated by UV light radiated to the UV adhesive film by a UV light irradiator is insulated from the hot-melt adhesive by the first and second separators and the first and second gaskets.

6. The stack of claim 5, wherein an amount of the UV light radiated to the UV adhesive film by the UV light irradiator is adjusted to less than a designated level for a long period of a designated time or longer, so that the heat generated by the UV light radiated to the UV adhesive film is not heating the hot-melt adhesive beyond a transition temperature for the hot-melt adhesive.

7. The reworkable fuel cell stack of claim 1, wherein the at least one subgasket is provided in a structure configured such that the hot-melt adhesive is applied to both surfaces thereof, and is fixed to circumferences of a cathode of the membrane electrode assembly and a gas diffusion layer stacked outside the cathode.

8. The reworkable fuel cell stack of claim 1, wherein the at least one subgasket comprises:
a first subgasket configured such that the hot-melt adhesive is applied to both surfaces thereof, wherein the first subgasket is fixed to circumferences of a cathode of the membrane electrode assembly and a gas diffusion layer stacked outside the cathode; and
a second subgasket configured such that the hot-melt adhesive is applied to both surfaces thereof, and wherein the second subgasket is fixed to circumferences of an anode of the membrane electrode assembly and a gas diffusion layer stacked outside the anode.

9. The reworkable fuel cell stack of claim 8, wherein the first separator is adhered directly to the hot-melt adhesive applied to an outer surface of a first gasket fixed to an inner surface of the first separator, wherein the second separator is adhered directly to the hot-melt adhesive applied to an outer surface of the second subgasket, and wherein one surface and a remaining surface of both ends of an electrolyte membrane of the membrane electrode assembly are adhered to the hot-melt adhesive applied to inner surfaces of the first and second subgaskets.

10. The stack of claim 1, wherein the hot-melt adhesive is one selected from among a polyolefin-based adhesive, a styrene butadiene rubber-based adhesive, and butyl rubber having a softening point of 67-110° C.

11. The stack of claim 1, wherein the UV adhesive film comprises:
a film base formed of one selected from among polyethylene terephthalate (PET), polyethylene naphthalate (PEN), and an olefine-based material; and
an adhesive applied to both surfaces of the film base.

12. The stack of claim 11, wherein the adhesive applied to both surfaces of the film base is one selected from among an acrylic material, multifunctional acrylic urethane, and epoxy acryl.

13. The stack of claim 11, wherein the adhesive applied to both surfaces of the film base comprises 2,4,6-trimethylbenzoyldiphenyl phosphine oxide (TPO) as a photoinitiator configured to create radicals when the adhesive is irradiated with UV light.

14. The stack of claim 11, wherein the adhesive applied to both surfaces of the film base comprises a UV absorber or a light stabilizer configured to adjust sensitivity to UV light.

15. The stack of claim 1, further comprising third gaskets between the first separator and the third separator and between the second separator and the fourth separator, in addition to the UV adhesive film.

16. The stack of claim 1, wherein an adhesion area of the UV adhesive film is reduced to less than an application area of the hot-melt adhesive so that heat capacity generated by UV light radiated to the UV adhesive film is set to a level not to melt the hot-melt adhesive.

17. A reworkable fuel cell stack comprising:
one fuel cell comprising a membrane electrode assembly;
a first separator and a second separator stacked on both surfaces of the membrane electrode assembly;
at least one subgasket fixed to a circumference of the membrane electrode assembly; and
a hot-melt adhesive applied to both surfaces of the at least one subgasket so as to be adhered to inner surfaces of the first separator and the second separators.

18. A method of repairing a reworkable fuel cell stack, the method comprising:
radiating UV light on a first UV adhesive film, wherein the first UV adhesive film is adhering between an outer surface of a first separator of a first fuel cell and a third separator of a second fuel cell, such that the first UV adhesive film reduces its adhesive force;
radiating UV light on a second UV adhesive film, wherein the second UV adhesive film is adhering between an outer surface of a second separator of the first fuel cell and a fourth separator of a third fuel cell, such that the second UV adhesive film reduces its adhesive force;
removing the first fuel cell; and
inserting and adhering a replacement fuel cell, such that the replacement fuel cell is adhered to the third separator of the second fuel cell and the fourth separator of the third fuel cell.

19. The method of claim 18, further comprising:
heating a hot-melt adhesive, wherein the hot-melt adhesive is applied to two surfaces of a subgasket, the subgasket being fixed to a circumference of a first membrane electrode assembly of the first fuel cell, such that the hot-melt adhesive reduces its adhesive force;
removing the first membrane electrode assembly from the first fuel cell; and
inserting and adhering a replacement membrane electrode assembly in the first fuel cell, such that the first fuel cell becomes the replacement fuel cell.
